(19) United States
(12) Patent Application Publication
(10) Pub. No.: US 2013/0158215 A1
(43) Pub. Date: Jun. 20, 2013

(54) MODIFIED ZIEGLER-NATTA CATALYST SYSTEMS

(71) Applicants: Elsa Martigny, Clermont-Ferrand (FR); Vincent Monteil, Lyon (FR); Roger Spitz, Lyon (FR); Aurélien Vantomme, Bois-d'Haine (BE)

(72) Inventors: Elsa Martigny, Clermont-Ferrand (FR); Vincent Monteil, Lyon (FR); Roger Spitz, Lyon (FR); Aurélien Vantomme, Bois-d'Haine (BE)

(21) Appl. No.: 13/698,025

(22) PCT Filed: May 19, 2011
(86) PCT No.: PCT/EP11/58130

§ 371 Date: Jan. 2, 2013

(30) Foreign Application Priority Data
May 25, 2010 (EP) 10163747.8

(51) Int. Cl. C08F 4/685; C08F 210/16; C08F 10/02; C08F 4/646; C08F 4/68

(52) U.S. Cl. CPC C08F 4/685; C08F 4/646; C08F 4/68; C08F 10/02; C08F 210/16
USPC 526/113; 502/104; 502/134

(57) ABSTRACT

This invention relates to modified Ziegler-Natta catalyst systems that have an excellent activity in homo- or co-polymerisation of ethylene and alpha-olefins and are able to produce polymers having reduced molecular weight distribution and improved incorporation of hexene with respect to conventional Ziegler-Natta catalyst systems.

### FIELD OF THE INVENTION

This invention relates to modified Ziegler-Natta catalyst systems that are able to produce polyethylene having reduced molecular weight distribution and improved incorporation of hexene with respect to conventional Ziegler-Natta catalyst systems.

### DESCRIPTION OF THE RELATED ART

Ziegler-Natta catalyst systems are multi-site catalyst systems that typically produce polymers having a mixture of chains having different tacticities, an heterogeneous composition and properties linked to crystallisation that are not optimal as described for example by Mulhaupt, R. In Macromol. Chem. Phys., 2003, 204, 289-327. For example, polyethylene prepared with Ziegler-Natta catalysts systems are characterised by a heterogeneous composition. In addition comonmer incorporation is far from ideal.

A large effort was spent to improve the activity and tacticity of these catalyst systems such as for example by Galli et al. in J. Polym. Sci. Part A: Polym. Chem. 2004, 42, 396-415. The last generations of Ziegler-Natta catalyst system have an excellent productivity and the addition of a Lewis base allows the selection of isospecific sites having a high isotactic index, but they still leave a diversity of sites, both in stereospecificity and in kinetic parameters as described for example by Chadwick et al. in Macromol. Chem. Phys. 2001, 202, 1998-2002.

Metallocene and post-metallocene catalyst systems on the contrary are single site catalyst systems that produce often a narrow composition distribution and uniform crystallisation but these catalysts systems are costly and difficult to prepare as explained for example by Mulhaupt, R. in Macromol. Chem. Phys. 2003, 204, 289-327.

In today's polymer production, the MgCl₂/TiCl₄ catalyst system is largely used to prepare polyethylene and polypropylene leaving a very limited part to metallocene catalyst systems.

Conventional Ziegler-Natta catalyst systems are typically based on a support (MgCl₂), TiCl₄ and internal Lewis base, so designed as precatalysts, and they are activated with AIR₃ and eventually an external Lewis base, so designed as cocatalyst.

It is thus very desirable to prepare Ziegler-Natta catalyst systems that offer some of the advantages of single site catalyst systems but are easier and less costly to prepare than the currently available single site systems.

### SUMMARY OF THE INVENTION

It is an objective of the present invention to provide a method for modifying Ziegler-Natta catalyst systems by modifying the oscillations of the titanium atoms, organised in clusters, inside the active sites.

It is also an objective of the present invention to prepare modified Ziegler-Natta catalyst system having a controlled behaviour in composition and molecular weight distribution.

It is another objective of the present invention to produce modified Ziegler-Natta catalyst systems that have and keep a good activity.

It is yet another objective of the present invention to prepare polyethylene having a controlled hexene incorporation with the modified Ziegler-Natta catalyst system.

It is a further objective of the present invention to prepare polyethylene having a reduced molecular weight distribution with the modified catalyst system.

In accordance with the present invention, the foregoing objectives are realised as described in the independent claims. Preferred embodiments are described in the dependent claims.

### DETAILED DESCRIPTION OF THE INVENTION

Accordingly, the present invention discloses a method for modifying a Ziegler-Natta catalyst by introducing on the surface of a precatalyst support or of a finished Ziegler-Natta precatalyst component, either a solution containing a chloride MClₙ wherein M is selected from Groups 3, 4, 5 or 6 of the Periodic Table and n is the valency of M, or a solid chloride MClₙ followed by the addition of TiCl₄, or a titanium halide wherein the halogen is not chlorine, said modification resulting in changing the Ti active site electronic environment.

Without wishing to bound by a theory, the active sites are believed to be organised in titanium clusters as explained for example in Monteil et al. in J. Polym. Sci. Part A: Polym. Chem. 2009, 47, 5784-5791. It is believed that introducing an heteroatom in such active clusters leads to a change of electronic environment that can result in a change of the oscillation rates around the metallic centres caused by Ti—Cl bounds oscillations. Such oscillations of ligands around a metal centre between various active sites conformations has been observed with metallocene based catalysts catalysis by Waymouth et al in Science 1995, 267, 217-219.

It has been observed, for example in EP-A-1,845,112 and in Monteil et al. in J. Polym. Sci. Part A: Polym. Chem. 2009, 47, 5784-5791 that the Ziegler-Natta pre-catalyst consists of a combination of active titanium sites and activating titanium sites. In that work, some of the activating titanium sites were removed by a thermal treatment. The pre-catalyst was then treated with a Lewis acid to fill the vacated titanium sites with boron activating sites that were more efficient than the titanium activating sites. In addition, it was evidenced that the active titanium sites are organised in clusters.

Such active site organisation undergoes changes of state as a function of time. There are oscillations between structural states of the sites caused by the sharing of chlorine atoms. As a result, the same site can produce both short and long chains at different times. If the structural changes of the catalyst system occur faster than the chain growth, all chains produced during the polymerisation reaction are different. This results in large polymer variability, large polydispersity index, broad polymer composition and poor comonomer insertion. In order to improve that undesirable situation, two options are available: either increase the polymerisation rate or slow down the structural changes of the pre-catalyst i.e. oscillations rates inside active site clusters.

The present invention discloses the second option wherein the structural changes of the pre-catalyst can be slowed down by either or both of two different mechanisms. Either an heteroatom having a valence and a geometry different from that of titanium is introduced on the precatalyst support or finished precatalyst, said heteroatom, in association with TiCl₄ acting to modify or block the sites oscillations. Or ligands having another chemistry than that of TiCl₄, wherein chlorine is replaced by another halogen, is introduced on titanium.

In a first embodiment according to the present invention, a solution of chloride MClₙ is added to the surface of a precatalyst support, said support being typically MgCl₂, wherein M has a higher molecular weight than titanium and a valence that is the same as or different from that of titanium. Preferably, the chloride MClₙ is soluble in hot TiCl₄ and a solution of MClₙ in hot TiCl₄ is added to the solid support, wherein M represents a metal and n is its valence. The solubility of metal chlorides in hot TiCl₄ at a temperature of 100° C. has been studied for example by Ehrlich and Dietz (P. Ehrlich. and G. Dietz in Zeitschrift Anorganische and Allgemeine Chemie, 305, 158-168, 1960). Preferably, the metal is selected from Groups 3, 4, 5 and 6 of the Periodic Table, more preferably, it is selected from Ta, Zr, Nb, Y or Nd, more preferably, Ta, Zr and Nb and most preferably Ta. The anchorage around a heavier atom, in terms of valence or molecular weight, changes the oscillations around the active sites and additionally interacts with the chlorine ligand.

Tantalum chloride is particularly preferred. It is available in large amount, is cheap, insoluble in the solvents that typically dissolve polymers and inert in polymerisation reactions. It is partially soluble in TiCl₄ at temperatures ranging between 70 and 130° C. and thus the impregnation of the catalyst with the mixture TiCl₄/TaCl₅ can easily be carried out. It must be noted that tantalum chloride cannot be impregnated directly alone onto the support. It must be associated with titanium chloride which is added either simultaneously when the metal chloride is dissolved in TiCl₄ or consecutively when MClₙ is added first in solid form.

The molar ratio of metal chloride to support MClₙ/MgCl₂ can vary between 0.015 and 0.2, preferably between 0.02 and 0.1, more preferably between 0.025 and 0.05. Titanium chloride is added in large excess with respect to the metal chloride. If the amount of added metal chloride is too large, for example for a ratio TaCl₅/MgCl₂≧0.2, MgCl₂ structure is lost and the catalyst is poisoned.

The impregnation of the precatalyst support can be carried out:
either in one step by dissolving metal chloride MClₙ into hot titanium chloride and then adding the hot solution to the support;
or in two steps by adding solid metal chloride MClₙ to the support and then adding titanium chloride.

The support is typically selected from MgCl₂.

The impregnation reaction is then carried out at a temperature ranging between room temperature and 130° C., preferably between 70° C. and 120° C., more preferably between 90 and 120° C., for a period of time of from 1 to 3 hours. The temperature of impregnation modifies the type of association between titanium and the other metal because it modifies the solubility of said other metal in titanium tetrachloride and therefore the amount of the other metal efficiently in contact with the surface of MgCl₂. It is indeed observed that modifying the impregnation temperature of titanium chloride alone does not increase the activity of the final catalyst system, whereas increasing the temperature from 90° C. to 120° C. when impregnating the support with a mixture metal chloride/titanium chloride at least doubles the activity of the final catalyst in the copolymerisation of ethylene and hexene. There is therefore a synergistic effect between titanium and the other metal in the activity and insertion mechanism of the comonomer in the growing polymer chain. The comonomer is inserted more regularly into the polymer.

The final polymer obtained according to the present invention is therefore influenced
by the mode of operation, either one or two steps impregnation
by the temperature of impregnation and
by ratio of metal chloride to MgCl₂ support.

For example, for an impregnation temperature of 120° C., the final polymer obtained with the present modified Ziegler-Natta catalyst system contains two populations:
a high density polyethylene type polymer characterised by few comonomer insertions and
waxes characterised by excellent comonomer insertion.

The present catalyst system is thus able to modify the properties of the resulting polymer by modifying the distribution of active sites on the support while maintaining very high activities.

It is further observed that the activity of the final catalyst depends strongly upon the method of impregnation, either one-step or two-step, the two-step method giving systematically a higher activity than the one-step method.

In another embodiment according to the first option, a finished Ziegler-Natta precatalyst system is further impregnated with titanium chloride and another metal chloride either using the one-step process or the two-step process disclosed hereabove:
either a solution of metal chloride in hot titanium chloride is added to the finished precatalyst
or solid metal chloride is first added to the finished precatalyst followed by the addition of titanium chloride.

The impregnation reaction is then carried out at a temperature ranging between 70 and 130° C. for a period of time of from 1 to 3 hours. In this particular embodiment, the one-step method leads to a substantial improvement in activity whereas the two-step method results in a severe reduction in activity. It is therefore concluded that too much additional metal poisons the catalyst and that there is an optimal ratio molar Ti/M of the final catalyst ranging between 3:1 and 1:1.

In a second embodiment according to the present invention, another titanium halide is added to the surface of the precatalyst support, typically MgCl₂. It is a titanium halide, wherein the halogen is not chlorine. It is selected preferably from iodine or bromine. More preferably it is bromine. In this embodiment, the oscillations of chlorine sites are blocked by the halide ligand whereas in the first embodiment they are blocked by the metallic centre.

The impregnation of the pre-catalyst support can also be carried out:
either in one step by dissolving the titanium halide into hot titanium chloride and then adding the hot solution to the support (MgCl₂);
or in two steps by adding a solid titanium halide to the support and then adding titanium chloride.

The impregnation reaction is then carried out at a temperature ranging between 70° C. and 130° C., preferably between 90° C. and 120° C. for a period of time of from 1 to 3 hours.

The molar ratio of titanium halide to support TiX₄/MgCl₂ can vary between 0.015 and 0.2, preferably between 0.02 and 0.1, more preferably between 0.025 and 0.055. Titanium chloride is added in large excess with respect to the titanium halide.

In all cases, the two-step method leads to higher activities than the one-step method.

The titanium halide can be added either at once or progressively, to the titanium chloride. In the first instance, the support detects the final concentration whereas in the second instance, it detects a concentration gradient. The active sites are therefore formed differently.

In another embodiment according to the second option, a Ziegler-Natta catalyst system is further impregnated with titanium chloride and titanium halide using either the one-step process or the two-step process:
either a solution of titanium halide in hot titanium chloride is added to the finished precatalyst
or solid titanium halide is first added to the finished precatalyst followed by the addition of titanium chloride.

The impregnation reaction is then carried out at a temperature ranging between 70 and 130° C., preferably between 90 and 120° C., for a period of time of from 1 to 3 hours.

Both methods lead to a decrease in polydispersity index and in some cases to a decrease in melting temperature with excellent activity.

The temperature of impregnation modifies the type of association between titanium, chloride and the other halogen because it modifies their structure. It is indeed observed that increasing the temperature from 70° C. to 120° C. when impregnating the support with a mixture titanium halide/titanium chloride substantially increases the activity of the final catalyst in the copolymerisation of ethylene and hexene. It also decreases the melting temperature of the final polymer.

As in the first embodiment, the final polymer obtained according to the present invention is therefore influenced
by the mode of operation, either one or two steps impregnation
by the temperature of impregnation and
by ratio of metal halide to MgCl₂ support;

For example, for an impregnation temperature of 120° C., the final polymer obtained with the present modified Ziegler-Natta catalyst system contains two populations:
high density polyethylene type polymer characterised by few comonomer insertions and
waxes characterised by excellent comonomer insertion.

Such mixture results from the presence of two families of active sites at the surface of the catalyst.

Further treatment with Lewis acids can modify the activity of the catalyst system and the polydispersity index and melting temperature of the resulting polymer. These properties are determined by the size and valence of the Lewis acid, but all tested Lewis acid had an influence on the final properties of the polymers.

### EXAMPLES

A Ziegler-Natta conventional catalyst is an association of a precatalyst and a cocatalyst. The precatalyst system is composed of a magnesium dichloride support, titanium tetrachloride and eventually an internal Lewis base for propylene polymerisation. The cocatalyst system is composed of trialkylaluminium and, in the case of polypropylene, an external Lewis base.

### General Considerations

All manipulations (catalyst synthesis and modifications) were performed using standard Schlenk techniques under an argon atmosphere, and solvents were dried under argon over molecular sieves.

Molecular weights of the polyethylenes were determined by high temperature Size Exclusion Chromatography (SEC) with a Water Alliance GPCV 2000 instrument (columns: Plgel Olexis 7×300 mm, Polymer Laboratories; two detectors: viscosimeter and refractometer in trichlorobenzene (flow rate: 1 mL/min) at 150° C.). The system was calibrated with polystyrene standards using universal calibration. Reported molecular weights are absolute values.

Thermal properties were measured by Differential Scanning calorimetry (DSC) on a Perkin Elmer Pyris at a heating rate of 5 K/min. The sample is first heated up to 150° C. at 5 K/min to erase its thermal history, then cooled down to 40° C. at 5 K/min, heated a second time up to 150° C. at 5 K/min and cooled down to room temperature at 20° C./min. DSC data reported (Tm values) are measured during the second heating phase.

Copolymer microstructures were determined by NMR ¹³C analysis on a BRUKER DRX 400 spectrometer operating at 400 MHz in trichlororbenzene (TCB) and perdeuterobenzene (C₆D₆) at 120° C.

### Example A-1

### Reference Precatalyst Synthesis at 90° C. And Polymerisation Procedure with the Corresponding Precatalyst

Following the method of EP-A-488856 A1, commercial anhydrous MgCl₂ was introduced in a argon-filled balloon with an excess of THF and stirred at reflux during 4 hours. Still at reflux temperature, heptane was added to the solution drop by drop during one hour. The solid was then washed four times with heptane at room temperature. Finally the MgCl₂ support was dried under high vacuum (10⁻⁹ bar) during several days until obtaining the structure MgCl₂-xTHF (x=0.5).

MgCl₂ support was then introduced in an argon-filled Schlenk flask. The solid was contacted with an excess of pure TiCl₄ solution at a temperature of 90° C. during 2 hours. The solid was then washed twice with toluene at a temperature of 90° C. and three times with heptane at room temperature. Finally, the precatalyst was dried under vacuum at room temperature.

Copolymerisation of ethylene with hexene was carried out using the following procedure.

A 1 L stainless steel reactor equipped with a stainless steel blade was used to polymerise ethylene. AlEt₃ (3 mmol/L), hexene (35% wt) and the (modified or not) Ziegler-Natta precatalyst were, respectively introduced in a flask containing 300 mL of heptane. The mixture was introduced into the reactor under a stream of ethylene, at room temperature. Then, 1 bar of hydrogen was injected into the reactor followed by ethylene. The temperature was adjusted to 80° C. and the total pressure to 7 bar. The total pressure of the reactor was kept constant at 7 bar during the entire reaction by continuous ethylene feed. Polymerisations were stopped when about 20 g of PE were produced. After the desired reaction time, the reactor was cooled and the gas pressure released. The polymer was then filtered off from the polymer suspension, washed with methanol then dried under vacuum for 1 hour at a temperature of 100° C. It corresponded either to the whole polymer produced or to the high density polyethylene fraction. The evaporation of the resulting heptane solution determined the soluble fraction of PE in cold heptane (also called waxes).

The results are displayed in Table I.

TABLE I

| | T | Activity | Tm | Mn | Mw | | % wt |
|---|---|---|---|---|---|---|---|
| Ex | ° C. | g/g/h | ° C. | g/mol | g/mol | PDI* | C₆ |
| A-1 | 90 | 21150 | 129.9 | 29009 | 218767 | 7.54 | 1.2 |

*PDI = polydispersity index defined as the ratio Mw/Mn of the weight average
molecular weight Mw over the number average molecular weight Mn. The number
average molecular weight Mn and the weight average molecular weight Mw were
determined by Size Exclusion Chromatographie (SEC).

### Example A-2

### Reference Precatalyst Synthesis at 120° C. And Polymerisation Procedure with the Corresponding Precatalyst

The same procedure as that used in Example A-1 was performed except that the impregnation temperature was increased to 120° C.

Copolymerisation of ethylene with hexene was carried out using procedure described in Example A-1. The results are displayed in Table II.

TABLE II

| | T | Activity | Tm^{a} | Mn^{a} | Mw^{a} | | |
|---|---|---|---|---|---|---|---|
| Ex | ° C. | g/g/h | ° C. | g/mol | g/mol | PDI | Waxes |
| A-2 | 120 | 15300 | 128.3 | 20705 | 94651 | 4.6^{a} | 0. 5% wt |
| | | | | | | (5.0)^{b} | |

^{a}Mesured from the high density polyethylene fraction
^{b}Corrected PD: polydispersity index defined as the ratio Mw/Mn, considering both high density polyethylene fraction and waxes fraction.

With this catalyst, two fractions of polymer were obtained: 99.5 wt % of crystalline polymer (high density polyethylene fraction) and 0.5 wt % of waxes soluble in cold heptane. These waxes were identified as copolymers of ethylene and hexene having 11.5 mol % of inserted hexene.

### Example 1

A first set of experiments was carried out according to the first embodiment of the present invention, by adding tantalum chloride to the support. The molar ratios TaCl₅/MgCl₂ selected were respectively of 0.2, 0.1, 0.05 and 0.025.

In a first mode of operation (called Mode 1), a solution of TaCl₅ dissolved in hot TiCl₄ (90° C.) was added to the MgCl₂ support in the preselected ratios of TaCl₅ over MgCl₂. The impregnation reaction was carried out at a temperature of 90° C. for a period of time of 2 hours. The impregnated support was washed twice with toluene at high temperature and three times with heptane at room temperature. Finally, the precatalyst was dried under vacuum at room temperature.

In a second mode of operation (called Mode 2), solid TaCl₅ was added to the support in the preselected ratios. Excess of TiCl₄ was then added and the impregnation reaction was carried out at a temperature of 90° C. for 2 hours. The impregnated support was washed twice with toluene at high temperature and three times with heptane at room temperature. Finally, the precatalyst was dried under vacuum at room temperature.

These 2 sets of treated supports were then used in the copolymerisation of ethylene and hexene. The polymerisation was carried out using the procedure described in Example A-1. The results are displayed in Table III.

TABLE III

| | | | Activity | Tm | Mn | Mw | | | % wt |
|---|---|---|---|---|---|---|---|---|---|
| Ex | TaCl₅/MgCl₂ | Mode | g/g/h | ° C. | g/mol | g/mol | PDI | Waxes | C₆ |
| A-1 | — | | 21150 | 129.9 | 29009 | 218767 | 7.54 | no | 1.2 |
| 1-1 | 0.2 | 1 | 685 | 130.5 | 50735 | 201255 | 3.97 | no | nd |
| 1-2 | 0.2 | 2 | 3584 | 130.8 | 33898 | 151153 | 4.46 | no | nd |
| 1-3 | 0.1 | 1 | 2290 | 131.5 | 41665 | 190780 | 4.58 | no | nd |
| 1-4 | 0.1 | 2 | 5600 | 129.4 | 27365 | 127314 | 4.65 | no | nd |
| 1-5 | 0.05 | 1 | 1122 | 131.76 | 33778 | 160283 | 4.75 | no | nd |
| 1-6 | 0.05 | 2 | 19600 | 127.4 | 31727 | 146174 | 4.61 | no | 1.7 |
| 1-7 | 0.025 | 1 | 9790 | 128.7 | 28652 | 138379 | 4.83 | no | nd |
| 1-8 | 0.025 | 2 | 17000 | 129.4 | 29999 | 124816 | 4.16 | no | nd |

All polymerisations carried out using the catalyst prepared according to the Mode 2 had a much higher activity than those carried out using the catalyst prepared according to the Mode 1.

In all cases, a substantial decrease of polydispersity index was observed, from 7.54 for a classical Ziegler-Natta catalyst to less than 5 for the catalysts of the present invention.

The melting temperature Tm was modified, but no trend was observed.

In example 1-6 TM was decreased, and more hexene was inserted in the polymer chain (NMR results, % wtC₆).

### Example 2

The impregnation reaction was carried out using the second mode of operation (Mode 2) of Example 1 and the impregnation temperature was varied between 70 and 120° C. Copolymerisation of ethylene and hexene was carried using the same procedure as that described in Example A-1. The results are displayed in Table IV.

TABLE IV

| | | T | Activity | Tm^{a} | Mn^{a} | Mw^{a} | | | % wt |
|---|---|---|---|---|---|---|---|---|---|
| Ex | TaCl₅/MgCl₂ | ° C. | g/g/h | ° C. | g/mol | g/mol | PDI^{a} | Waxes | C₆^{a} |
| A-1 | — | 90 | 21150 | 129.9 | 29009 | 218767 | 7.54 | no | 1.2 |
| A-2 | — | 120 | 15300 | 128.3 | 20705 | 94651 | 4.6 (5)^{b} | 0.5% wt | nd |
| 2-1 | 0.05 | 70 | 700 | 130.8 | nd | nd | nd | no | nd |
| 2-2 | 0.05 | 90 | 19600 | 127.4 | 31727 | 146174 | 4.61 | no | 1.7 |
| 2-3 | 0.05 | 120 | 33000 | 126.9 | 22851 | 159612 | 6.9 (8.1)^{b} | 3.5% wt | 2.7 |

^{a}Mesured from the high density polyethylene fraction
^{b}Corrected PDI: polydispersity index defined as the ratio Mw/Mn, considering both
high density polyethylene fraction and waxes fraction.

Waxes soluble in cold hexane were obtained with the catalyst prepared by impregnation at a temperature of 120° C. (example 2-3). These waxes were identified as copolymers of ethylene and hexene having 11.5 mol % of inserted hexene.

When increasing the temperature of the impregnation reaction, the activity increases, and the melting temperature decreases, corresponding to a better hexene insertion in the polymer chain. This can be observed by NMR in example 2-3 wherein 2.7% wtC₆ were inserted.

At a temperature of 120° C., waxes and high density polyethylene were produced indicating the presence of two types of active sites, one of which being very efficient for the insertion of hexene in the polymer chain.

### Example 3

In this example, the impregnation was carried out on a Ziegler-Natta catalyst instead of directly on MgCl₂ support. The finished Ziegler-Natta precatalyst was prepared according to the procedure of Example A-1.

The same two modes of operation as in example 1 were then used to modify the finished catalyst, they will be called Modes 4-1 and 4-2. The copolymerisation of ethylene and hexene was then carried out using the same procedure as that described in Example A-1. The results are displayed in Table V.

TABLE V

| | | | Activity | Tm | Mn | Mw | | | % wt |
|---|---|---|---|---|---|---|---|---|---|
| Ex | TaCl₅/MgCl₂ | Mode | g/g/h | ° C. | g/mol | g/mol | PDI | Waxes | C₆ |
| 3-1 | 0.05 | 4-1 | 67000 | 127.8 | 29122 | 174139 | 5.98 | no | 2.6 |
| 3-2 | 0.05 | 4-2 | 9600 | 129.5 | 35792 | 208012 | 5.81 | no | nd |

The first mode of impregnation (Mode 4-1) led to an drastic gain in activity that was not observed for the Mode 4-2. Both modes of impregnation led to a reduction of polydispersity index but the reduction was not as marked as in Example 1.

The Mode 4-1 led to a decrease of melting temperature and a better insertion of comonomer.

### Example 4

Another set of experiments was carried out according to the first embodiment of the present invention, by adding zirconium chloride to the MgCl₂ support. The molar ratios ZrCl₄/MgCl₂ selected were respectively of 0.2, 0.1, and 0.05.

In a first mode of operation (Mode 1), a solution of ZrCl₄ dissolved in hot TiCl₄ (90° C.) was added to the support in the preselected ratios of ZrCl₄ over MgCl₂. The impregnation reaction was carried out at a temperature of 90° C. for a period of time of 2 hours. The impregnated support was washed twice with toluene at high temperature and three times with heptane at room temperature. Finally, the precatalyst was dried under vacuum at room temperature.

In a second mode of operation (Mode 2), dry ZrCl₄ was added to the support in the preselected ratios. Excess of TiCl₄ was then added and the impregnation reaction was carried out at a temperature of 90° C. for a period of time of 2 hours. The impregnated support was washed twice with toluene at hight temperature and three times with heptane at room temperature. Finally, the precatalyst was dried under vacuum at room temperature.

These 2 sets of treated supports were then used in the copolymerisation of ethylene and hexene using the procedure described in Example A-1. The results are displayed in Table VI.

TABLE VI

| | | | Activity | Tm | Mn | Mw | | | % wt |
|---|---|---|---|---|---|---|---|---|---|
| Ex | ZrCl₄/MgCl₂ | Mode | g/g/h | ° C. | g/mol | g/mol | PDI | Waxes | C₆ |
| A-1 | — | | 21150 | 129.9 | 29009 | 218767 | 7.54 | no | 1.2 |
| 4-1 | 0.2 | 2 | 10000 | 128.6 | 30275 | 180473 | 5.96 | no | nd |
| 4-2 | 0.1 | 2 | 21970 | 128.1 | 25994 | 154909 | 5.96 | no | 1.8 |
| 4-3 | 0.05 | 1 | 2200 | 129.9 | 37699 | 204981 | 5.44 | no | nd |
| 4-4 | 0.05 | 2 | 8285 | 127.3 | 28360 | 165433 | 5.83 | no | 1.6 |

All polymerisations carried out using the catalyst prepared according to the second mode of operation had a much higher activity than those carried out using the catalyst prepared according to the first mode of operation.

In all cases, a substantial decrease of polydispersity index was observed, from 7.54 for a classical Ziegler-Natta catalyst to less than 6 for the catalysts of the present invention.

The melting temperature was modified, generally decreased, with a better comonomer insertion (examples 4-2 and 4-4).

### Example 5

The impregnation reaction was carried out using the second mode of operation of Example 4 and the impregnation temperature was varied between 70 and 120° C. Copolymerisation of ethylene and hexene was carried using the same procedure as that described in Example A-1. The results are displayed in Table VII.

TABLE VII

| | | T | Activity | Tm^{a} | Mn^{a} | Mw^{a} | | | % wt |
|---|---|---|---|---|---|---|---|---|---|
| Ex | ZrCl₄/MgCl₂ | ° C. | g/g/h | ° C. | g/mol | g/mol | PDI^{a} | Waxes | C₆^{a} |
| A-1 | — | 90 | 21150 | 129.9 | 29009 | 218767 | 7.5 | no | 1.2 |
| A-2 | — | 120 | 15300 | 128.3 | 20705 | 94651 | 4.6 (5)^{b} | 0.5% wt | nd |
| 5-1 | 0.05 | 70 | 1800 | 131 | 29861 | 170769 | 5.7 | no | nd |
| 5-2 | 0.05 | 90 | 8285 | 127.3 | 28360 | 165433 | 5.8 | no | 1.6 |
| 5-3 | 0.05 | 120 | 21700 | 126.9 | 23281 | 156454 | 6.7 (8.7)^{b} | 3.2% wt | 2.9 |

^{a}Mesured from the high density polyethylene fraction
^{b}Corrected PD: polydispersity index defined as the ratio Mw/Mn, considering both
high density polyethylene fraction and waxes fraction.

Waxes soluble in cold hexane were obtained with the catalyst prepared by impregnation at a temperature of 120° C. These waxes were identified as copolymers of ethylene and hexene having 11.1% of inserted hexene.

When increasing the temperature of the impregnation reaction, the activity increases, and the melting temperature decreases, which correspond to a better hexene insertion in the polymer chain as determined by measuring the % wtC₆ inserted by NMR analysis.

As in Example 2, at the temperature of 120° C., waxes and high density polyethylene were produced indicating the presence of two types of active sites, one of which being very efficient for the insertion of hexene in the polymer chain.

### Example 6

Another set of experiments was carried out according to the first embodiment of the present invention, by adding niobium chloride to the MgCl₂ support. The molar ratios NbCl₅/MgCl₂ selected were respectively of 0.2, 0.1, 0.05.

We only investigated the second mode of operation described in Example 1. Dry NbCl₆ was added to the support in the preselected ratios. Excess of TiCl₄ was then added and the impregnation reaction was carried out at a temperature of 90° C. for a period of time of 2 hours. The impregnated support was washed twice with toluene at high temperature and three times with heptane at room temperature. Finally, the precatalyst was dried under vacuum at room temperature.

These precalatysts were then used in the copolymerisation of ethylene and hexene. The polymerisation was carried out using the procedure described in Example A-1. The results are displayed in Table VIII.

TABLE VIII

| | NbCl₅/ | | Activity | Tm | Mn | Mw | | |
|---|---|---|---|---|---|---|---|---|
| Ex | MgCl₂ | Mode | g/g/h | ° C. | g/mol | g/mol | PDI | Waxes |
| A-1 | — | | 21150 | 129.9 | 29009 | 218767 | 7.54 | no |
| 6-1 | 0.2 | 2 | 5200 | 130 | 36064 | 192751 | 5.34 | no |
| 6-2 | 0.1 | 2 | 11000 | 129.8 | 36560 | 191077 | 5.22 | no |
| 6-3 | 0.05 | 2 | 16000 | 129.5 | 36541 | 191905 | 5.25 | no |

With the molar ratios NbCl₅/MgCl₂ of 0.05 and 0.1, catalysts kept a good activity compared to the reference A-1.

In all cases, a substantial decrease of polydispersity index was observed, from 7.54 for a classical Ziegler-Natta catalyst to less than 6 for the catalysts of the present invention.

The melting temperature was not as modified as for TaCl₅ (example 1).

### Example 7

Another set of experiments was carried out according to the first embodiment of the present invention, by adding yttrium chloride to the support. This time we only investigated the influence for a molar ratio of YCl₃/MgCl₂ equal to 0.05 of the moment of impregnation: either directly on MgCl₂ support (mode of operation 2) or on a finished Ziegler-Natta (mode of operation 4-1).

These precalatysts were then used in the copolymerisation of ethylene and hexene. The polymerisation was carried out using the procedure described in Example A-1. The results are displayed in Table IX.

TABLE IX

| | | | Activity | Tm | Mn | Mw | | | % wt |
|---|---|---|---|---|---|---|---|---|---|
| Ex | YCl₃/MgCl₂ | Mode | g/g/h | ° C. | g/mol | g/mol | PDI | Waxes | C₆ |
| A-1 | — | | 21150 | 129.9 | 29009 | 218767 | 7.54 | no | 1.2 |
| 7-1 | 0.05 | 2 | 0 | — | — | — | — | no | nd |
| 7-2 | 0.05 | 4-1 | 14500 | 130.3 | 37790 | 210182 | 5.6 | no | 0.9 |

Yttrium chloride, when added alone to the support (Mode 2) totally poisoed the catalyst.

With the Mode 4-1, the catalyst kept a good activity, and the polydispersity index decreased, but the melting temperature was not modified. A diminution of comonomer insertion was also observed.

### Example 8

Another set of experiments was carried out according to the first embodiment of the present invention, by adding neodyme chloride to the support. As for Example 7, we only investigated the influence on a molar ratio of NdCl₃/MgCl₂ equal to 0.05, of the moment of impregnation: either directly on MgCl₂ support (mode of operation 2) or on a finished Ziegler-Natta (mode of operation 4-1).

These precalatysts were then used in the copolymerisation of ethylene and hexene. The polymerisation was carried out using the procedure described in Example A-1. The results are displayed in Table X.

TABLE X

| | | | Activity | Tm | Mn | Mw | | | % wt |
|---|---|---|---|---|---|---|---|---|---|
| Ex | NdCl₃/MgCl₂ | Mode | g/g/h | ° C. | g/mol | g/mol | PDI | Waxes | C6 |
| A-1 | — | | 21150 | 129.9 | 29009 | 218767 | 7.54 | no | 1.2 |
| 8-1 | 0.05 | 2 | 7000 | 130.6 | 37003 | 226918 | 6.1 | no | 0.9 |
| 8-2 | 0.05 | 4-1 | 22000 | 130.1 | nd | nd | nd | no | nd |

With the Mode 4-1, the catalyst kept a good activity compared to the one of the reference A-1, and no changes in the polymer properties are observed.

### Example 9

According to the second embodiment, in this set of examples, a mixture of titanium chloride and titanium bromide was added to the support. As for example 1, two modes of operation were tested:
a first mode (Mode 1) in one step wherein a solution of TiBr₄ was dissolved in hot TliCl₄ (90° C.)
a second mode (Mode 2) in two steps wherein solid TiBr₄ was first added to the support followed by the addition of an excess of TiCl₄.

In both modes of operation, molar ratios TiBr₄/MgCl₂ respectively of 0.1, 0.055 and 0.025 were tested.

In both sets of examples, the impregnation reaction was carried out at a temperature of 90° C. for a period of time of 2 hours. The impregnated support was washed twice with toluene at hight temperature and three times with heptane at room temperature. Finally, the precatalyst was dried under vacuum at room temperature.

The copolymerisation of ethylene and hexene was carried out as in Example A-1. The results are displayed in Table XI.

TABLE XI

| | | | Activity | Tm | Mn | Mw | | | % wt |
|---|---|---|---|---|---|---|---|---|---|
| Ex | TiBr₄/MgCl₂ | Mode | g/g/h | ° C. | g/mol | g/mol | PDI | Waxes | C₆ |
| A-1 | — | | 21150 | 129.9 | 29009 | 218767 | 7.54 | no | 1.2 |
| 9-1 | TiBr₄ alone | — | 0 | — | — | — | — | — | — |
| 9-2 | 0.055 | 1 | 15500 | 128.63 | 23530 | 158081 | 6.72 | no | nd |
| 9-3 | 0.055 | 2 | 16300 | 127.4 | 18440 | 137204 | 7.44 | no | 2.0 |
| 9-4 | 0.1 | 2 | 21000 | 128.86 | 28876 | 152121 | 5.3 | no | nd |
| 9-5 | 0.025 | 2 | 16000 | 128.86 | 26589 | 143826 | 5.4 | no | nd |

Titanium bromide, when added alone (without TiCl₄) to the support did not produce an active catalyst. When added in combination with titanium chloride, it led in all cases, to an activity similar to that of a conventional Ziegler-Natta catalyst and produced polymers with a reduced melting temperature (better comonomer insertion for example 9-3) and a reduced polydispersity index.

### Example 10

This example was carried out in a manner similar to that of Example 3. The impregnation was carried out on a Ziegler-Natta catalyst instead of directly on MgCl₂ support. The Ziegler-Natta catalyst was prepared according to the procedure of Example A-1.

The second mode of operation of Example 9 was then used to modify the precatalyst. Post treatments respectively with heptane and TiCl₄ were carried out. The copolymerisation of ethylene and hexene was then carried out using the same procedure as that described in Example A-1. The results are displayed in Table XII.

TABLE XII

| | | | Activity | Tm | Mn | Mw | | | % wt |
|---|---|---|---|---|---|---|---|---|---|
| Ex | TiBr₄/MgCl₂ | Mode | g/g/h | ° C. | g/mol | g/mol | PDI | Waxes | C₆ |
| 10-1 | 0.055 | 2 | 16300 | 127.4 | 18440 | 137204 | 7.44 | no | 2.0 |
| 10-2 | 0.055 | 4-2 | 7000 | 130.53 | 20335 | 117086 | 5.8 | no | nd |
| 10-3 | 0.055 | 4-1 | 30000 | 128.94 | 27785 | 152982 | 5.5 | no | 1.2 |

Post-treatment with TiBr4 in solution in heptane poisoned the catalyst (example 10-2) whereas post treatment with TiCl₄ considerably improved the activity (10-3). Post-treatment increased the melting temperature and decreased the polydispersity index in all cases.

### Example 11

The impregnation reaction was carried out using the second mode of operation of Example 9 and the impregnation temperature was varied between 70 and 120° C. Copolymerisation of ethylene and hexene was carried using the same procedure as that described in Example A-1, except that in one test (example 11-4) no hydrogen was injected. The results are displayed in Table XIII.

TABLE XIII

| | | Temp. | H₂ | Activity | Tm^{a} | Mn^{a} | Mw^{a} | | | % wt |
|---|---|---|---|---|---|---|---|---|---|---|
| Ex | TiBr₄/MgCl₂ | ° C. | bar | g/g/h | ° C. | g/mol | g/mol | PDI^{a} | Waxes | C₆^{a} |
| A-1 | — | 90 | 1 | 21150 | 129.9 | 29009 | 218767 | 7.54 | no | 1.2 |
| A-2 | — | 120 | 1 | 15300 | 128.3 | 20705 | 94651 | 4.6 | 0.5 wt % | nd |
| | | | | | | | | (5)^{b} | | |
| 11-1 | 0.055 | 70 | 1 | 5200 | 130.35 | 24939 | 165970 | 6.7 | no | nd |
| 11-2 | 0.055 | 90 | 1 | 16300 | 127.4 | 18440 | 137204 | 7.4 | no | 2.0 |
| 11-3 | 0.055 | 120 | 1 | 17000 | 126.78 | 16558 | 105329 | 6.4 | 3 wt % | 2.4 |
| | | | | | | | | (7)^{b} | | |
| 11-4 | 0.055 | 120 | 0 | 19200 | 128.53 | 52205 | 479390 | 9.2 | no | nd |

^{a}Mesured from the high density polyethylene fraction
^{b}Corrected PD: polydispersity index defined as the ratio Mw/Mn, considering both
high density polyethylene fraction and waxes fraction.

In experiment 11-3 (impregnation at 120° C.), 3 wt % of waxes were obtained.

In conclusion, the activity increased with increasing temperature of the impregnation reaction and the melting temperature decreased with increasing impregnation temperature (better comonomer insertion).

Waxes and high density polyethylene were produced indicating the presence of two types of active sites, one of which being very efficient for the insertion of hexene in the polymer chain.

As expected, in the absence of hydrogen, acting as transfer agent, molar masses increased and low molecular weight components (waxes) disappeared. The polydispersity index increased.

### Example 12

Another set of experiments was carried out according to the second embodiment of the present invention, by adding a mixture of titanium chloride and titanium iodide. This time we investigated the influence of the molar ratio of TiI₄/MgCl₂ (0.025; 0.055; 0.1; excess), the mode of impregnation (either directly on the MgCl₂ support (mode of operation 2) or on a finished Ziegler-Natta precatalyst (mode of operation 4-1)) and the impregnation temperature.

These precalatysts were then used in the copolymerisation of ethylene and hexene. The polymerisation was carried out using the procedure described in Example A. The results are displayed in Table XIV.

TABLE XIV

| | | | Temp | Activity | Tm | Mn | Mw | | | % wt |
|---|---|---|---|---|---|---|---|---|---|---|
| Ex | Til₄/MgCl₂ | Mode | ° C. | g/g/h | ° C. | g/mol | g/mol | PDI | Wax | C₆ |
| A-1 | — | — | 90 | 21150 | 129.9 | 29009 | 218767 | 7.54 | no | 1.2 |
| 12-1 | 0.025 | 2 | 90 | 4400 | 130.9 | 51266 | 245025 | 4.8 | no | 1.1 |
| 12-2 | 0.055 | 2 | 90 | 0 | — | — | — | — | — | — |
| 12-3 | 0.1 | 2 | 90 | 5040 | 131.0 | 42868 | 237611 | 5 | no | nd |
| 12-4 | 0.055 | 2 | 120 | 8500 | 130.7 | 45226 | 317239 | 7.0 | no | nd |
| 12-5 | 0.055 | 4-1 | 90 | 35000 | 127.8 | 31256 | 185893 | 5.9 | no | 2.2 |

Contrary to Examples 9, 10 and 11, addition of TiI₄ on the MgCl₂ support poisoned the precatalyst.

However, when added on a Ziegler-Natta catalyst (example 12-5), TiI₄ led to a gain in activity and a reduction of melting temperature (better comonomer insertion).

1. A method for modifying a Ziegler-Natta catalyst by introducing on the surface of a precatalyst composed of a magnesium dichloride, or on the surface of a conventional Ziegler-Natta catalyst, composed of magnesium dichloride, titanium tetrachloride and optionally an internal Lewis base, either a solution containing a chloride MCln wherein M is selected from Groups 3, 4, 5 or 6 of the Periodic Table and n is the valency of M and wherein the solution containing MCln is hot TiCl4, or a solid chloride MCln followed by addition of TiCl4, or a titanium halide wherein the halogen is not chlorine, characterised in that said modification results in changing the Ti active site electronic environment.

2. The method of claim 1 wherein MCln is at least partially soluble in hot TiCl4.

3. The method of claim 1 wherein M is selected from Ta, Nb, Zr, Y or Nd, preferably Ta or Nb, more preferably Ta.

4. The method of claim 1 wherein the precatalyst support is MgCl₂.

5. The method of claim 1 wherein the molar ratio MClₙ/MgCl₂ ranges between 0.015 and 0.2, preferably between 0.02 and 0.1.

6. The method of claim 1 wherein the non-chlorine halogen is Br or I, preferably Br.

7. The method of claim 6 wherein the molar ratio TiX₄/MgCl₂ ranges between 0.015 and 0.2, preferably between 0.02 and 0.1.

8. The method of claim 1 wherein the modifying reaction is carried out at a temperature ranging between room temperature and 130° C., preferably from 70° C. to 120° C., for a period of time of from 1 to 3 hours.

9. The method of claim 1 wherein the temperature of the impregnation temperature is increased in order to increase the activity of the catalyst.

10. The method of claim 1 wherein the impregnation temperature is varied in order to modify the amount of non-titanium metal efficiently in contact with the surface of MgCl₂.

11. A modified Ziegler-Natta pre-catalyst obtained by the method of any one of claim 1.

12. Use of the modified Ziegler-Natta catalyst of claim 10 to prepare homo- or co-polymers of ethylene having a molecular weight distribution narrower than that of polyethylene obtained with the same Ziegler-Natta catalyst unmodified.

13. Use according to claim 11 wherein the comonomer, if present, is hexene.
